(19) United States
(12) Patent Application Publication
(10) Pub. No.: US 2005/0101207 A1
(43) Pub. Date: May 12, 2005

(54) Fragrance pad

(75) Inventors: Genevieve Bonnechere, Awans (BE); Jean Julemont, Verviers (BE); Alain Jacques, Blegny (BE)

Correspondence Address: Colgate-Palmolive Company, 909 River Road, P.O. Box 1343, Piscataway, NJ, 08855-1343, US

(73) Assignee: Colgate-Palmolive Company

(21) Appl. No.: 10/702,244

(22) Filed: Nov. 6, 2003

(51) Int. Cl. B32B 27/04

(52) U.S. Cl. 442/96

(57) ABSTRACT

A fragrance pad which comprises a water insoluble substrate which is impregnated with a fragrance solution, wherein an adhesive means is provided for affixing the water insoluble substrate to the interior surface of a garbage bag.

### FIELD OF THE INVENTION

The present invention relates to a fragrance pad which can be removably affixed to the interior surface of a trash bag which can be optionally disposed in a trash compactor.

### BACKGROUND OF THE INVENTION

A major problem is garbage maldor which develops in trash bag due to the decomposition of organic matter.

In order to suppress the garbage maldor in a trash bag consumers will typically spray a perfume disinfectant into the trash bag containing the decomposing organic matter.

U.S. Pat. No. 6,471,066 teaches a patch for repair a hole in a garbage bag but fails to address odors.

U.S. Pat. No. 6,231,937 teaches a garbage bag containing methyl nonyl ketone and pine oil which is designed to repel rodents.

### SUMMARY OF THE INVENTION

The present invention relates to a fragrance pad which comprises a substrate having at least one layer, a fragrance solution being impregnated into the substrate and a means for affixing the impregnated substrate to the interior surface of a garbage bag.

An object of the instant invention is to provide a fragrance pad which is used to suppress garbage maldor in a garbage bag caused by the decomposition of organic matter, wherein the fragrance pad comprises a substrate which has at least one layer of which one layer is at least a nonwoven fabric, a fragrance solution which is impregnated into the substrate and a means for affixing the impregnated substrate to the interior surface of a garbage bag.

### DETAILED DESCRIPTION OF THE INVENTION

The present invention relates to a fragrance pad which is designed to be affixed to the interior surface of a garbage bag which comprises approximately by weight:
(a) 60 wt. % to 99 wt. % of a water insoluble substrate;
(b) 1 wt. % to 40 wt. % of a fragrance solution being coated onto and/or impregnated into said water insoluble substrate, wherein said fragrance solution comprises:
   (i) 5 wt. % to 25 wt. % of at least one fragrance;
   (ii) 0.01 wt. % to 2.0 wt. % of at least one preservative; and
   (iii) 75 wt. % to 95 wt. % of at least one humectant; and
(c) means for affixing said water insoluble substrate to said interior surface of said garbage bag, wherein said fragrance solution does not contain an anionic surfactant, an alkyl polyglucoside surfactant, a zwitterionic surfactant, an amine oxide surfactant, a cationic surfactant and/or an ethoxylated nonionic surfactant.

As used herein and in the appended claims the term “perfume” or “fragrance” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced substance) odoriferous substances. Typically, perfumes are complex mixtures of blends of various organic compounds such as alcohols, aldehydes, ethers, aromatic compounds and varying amounts of essential oils (e.g., terpenes) such as from 0% to 80%, usually from 10% to 70% by weight, the essential oils themselves being volatile odoriferous compounds and also serving to dissolve the other components of the perfume.

In the present invention the precise composition of the perfume is of no particular consequence so long as it meets the criteria of water immiscibility and having a pleasing odor. The perfume should be cosmetically acceptable, i.e., non-toxic, hypoallergenic, etc.

The humectant is selected from the group consisting of glycerol, ethylene glycol, water-soluble polyethylene glycols having a molecular weight of 300 to 1000, polypropylene glycol of the formula HO(CH₃CHCH₂O)ₙH wherein n is a number from 2 to 18, mixtures of polyethylene glycol and polypropyl glycol (Synalox) and mono C₁-C₆ alkyl ethers and esters of ethylene glycol and propylene glycol having the structural formulas R(X)ₙOH and R₁(X)ₙOH wherein R is C₁-C₆ alkyl group, R₁ is C₂-C₄ acyl group, X is (OCH₂CH₂) or (OCH₂(CH₃)CH) and n is a number from 1 to 4, diethylene glycol, triethylene glycol, an alkyl lactate, wherein the alkyl group has 1 to 6 carbon atoms, 1methoxy-2-propanol, 1methoxy-3-propanol, and 1 methoxy 2-, 3- or 4-butanol, (2) aliphatic mono- and di-carboxylic acids containing 2 to 10 carbon atoms, preferably 3 to 6 carbons in the molecule; and (3) triethyl phosphate.

While all of the aforementioned glycol ether compounds are acceptable, the most preferred humectant compounds are diethylene or dipropylene glycol.

Representative members of the polypropylene glycol include dipropylene glycol and polypropylene glycol having a molecular weight of 200 to 1000, e.g., polypropylene glycol 400. Other satisfactory glycol ethers are ethylene glycol monobutyl ether (butyl cellosolve), diethylene glycol monobutyl ether (butyl carbitol), triethylene glycol monobutyl ether, mono, di, tri propylene glycol monobutyl ether, tetraethylene glycol monobutyl ether, mono, di, tripropylene glycol monomethyl ether, propylene glycol monomethyl ether, ethylene glycol monohexyl ether, diethylene glycol monohexyl ether, propylene glycol tertiary butyl ether, ethylene glycol monoethyl ether, ethylene glycol monomethyl ether, ethylene glycol monopropyl ether, ethylene glycol monopentyl ether, diethylene glycol monomethyl ether, diethylene glycol monoethyl ether, diethylene glycol monopropyl ether, diethylene glycol monopentyl ether, triethylene glycol monomethyl ether, triethylene glycol monoethyl ether, triethylene glycol monopropyl ether, triethylene glycol monopentyl ether, triethylene glycol monohexyl ether, mono, di, tripropylene glycol monoethyl ether, mono, di tripropylene glycol monopropyl ether, mono, di, tripropylene glycol monopentyl ether, mono, di, tripropylene glycol monohexyl ether, mono, di, tributylene glycol mono methyl ether, mono, di, tributylene glycol monoethyl ether, mono, di, tributylene glycol monopropyl ether, mono, di, tributylene glycol monobutyl ether, mono, di, tributylene glycol monopentyl ether and mono, di, tributylene glycol monohexyl ether, ethylene glycol monoacetate and dipropylene glycol propionate.

Preservatives which can be used in the instant compositions are: benzalkonium chloride; benzethonium chloride,5-bromo-5-nitro-1,3dioxane; 2-bromo-2-nitropropane-1,3-diol; alkyl trimethyl ammonium bromide; N-(hydroxymethyl)-N-(1,3-dihydroxy methyl-2,5-dioxo-4-imidaxolidinyl-N′-(hydroxy methyl) urea; 1-3-dimethyol-5,5-dimethyl hydantoin; formaldehyde; iodopropynyl butyl carbamata, butyl paraben; ethyl paraben; methyl paraben; propyl paraben, mixture of methyl isothiazolinone/methyl-chloroisothiazoline in a 1:3 wt. ratio; mixture of phenoxythanol/butyl paraben/methyl paraben/propylparaben; 2-phenoxyethanol; tris-hydroxyethyl-hexahydrotriazine; methylisothiazolinone; 5-chloro-2-methyl-4-isothiazolin-3-one; 1,2-dibromo-2,4-dicyanobutane; 1-(3-chloroalkyl)-3,5,7-triaza-azoniaadamantane chloride; and sodium benzoate.

An especially preferred preservative is glydant which is a mixture of 70 wt. % of DMDM/HMDM hydantoin, 4.5 wt. % of butane-1,3-diol; 25 wt. % of 3-iodo-2-propynyl butyl carbanate; 0.15 wt. % of formaldehyde and the balance being water. Another preferred preservative is glycacil which comprises 40 wt. % of polyethylene glycol monococoate, 40 wt. % of polyethylene glycol dicocoate; 10 wt. % of IPBC which is 3-iodo-2-propynyl butyl carbamate and 10 wt. % of polyethylene glycol.

The fragrance solution are prepared by simple batch mixing at 25° C.-30° C. The water insoluble substrate is impregnated with the liquid fragrance solution by means of a positive impregnation process. The solution is positively fed into the nonwoven fabric through a controlled gear pump and injection bar at a ratio of about 2 grams of the fragrance solution to about 100 gram of the nonwoven fabric.

The product of the present invention comprises a water insoluble substrate with one or more layers. Each layer may have different textures and abrasiveness. Differing textures can result from the use of different combinations of materials or from the use of different manufacturing processes or a combination thereof. A dual texture substrate can be made.

A wide variety of materials can be used as the substrate. It should have sufficient wet strength, abrasivity, loft and porosity. Examples include, non woven substrates, wovens substrates, hydroentangled substrates and sponges.

One water insoluble is a nonwoven fabric which is manufactured by Dexter Corporation under the name Hydraspun comprises about 60% to 95% of wood pulp fabrics, 2.5 wt. % to 20 wt. % of viscose fibers and 2.5 wt. % to 20 wt. % of polyester fibers.

Examples of suitable non woven water insoluble substrates include, 100% cellulose Wadding Grade 1804 from Little Rapids Corporation, 100% polypropylene needlepunch material NB 701-2.8—W/R from American Non-wovens Corporation, a blend of cellulosic and synthetic fibres-Hydraspun 8579 from Ahlstrom Fibre Composites, and 70% Viscose/30% PES Code 9881 from PGI Nonwovens Polymer Corp.

Another useful substrate is manufactured by Jacob Holm-Lidro Rough. It is a composition material comprising a 65/35 viscose rayon/polyester hydroentangled spunlace layer with a hydroenlongated bonded polyester scribbly layer.

Still another useful substrate is manufactured by Texel. It is a composite material manufactured from a layer of coarse fiber 100% polypropylene needlepunch, an absorbent cellulose core and a fine fiber polyester layer needlepunched together. The polypropylene layer can range from 1.5 to 3.5 oz/sq. yd. The cellulose core is a creped paper layer ranging from 0.5 to 2 oz./sq. yd. The fine fiber polyester layer can range from 0.5 to 2 oz./sq. yd.

Still another composite material manufactured by Texel from a layer of coarse fiber 100% polypropylene needlepunch layer, an absorbent cellulose core and a fine fiber polyester layer needlepunched together. The polypropylene layer can range from 1.5 to 3.5 oz/sq. yd. The cellulose core is a creped paper layer ranging from 0.5 to 2 oz/sq. yd. The fine fiber polyester layer can range from 0.5 to 2 oz/sq. yd.

A composite dual textured material manufactured by Kimberly Clark comprises a coarse meltblown polypropylene, polyethylene, or polyester and high loft spunbond polyester. The two materials can be laminated together using chemical adhesives or by coprocessing the two layers. The coarse meltblown layer can range from 1 to 3 ounces per square yard while the highloft spunbond layer can range from 1 to 3 ounces per square yard.

Another example of a composite is a dual textured material composed of coarse meltblown polypropylene, polyethylene, or polyester and polyester/cellulose coform. The two materials can be laminated together using chemical adhesives or by coprocessing the two layers. The coarse meltblown layer can range from 1 to 3 ounces per square yard. The coform layer can range in composition from 30% cellulose and 70% polyester to 70% cellulose and 30% polyester and the basis weight can range from 1.5 to 4.5 ounces per square yard.

The product of the present invention comprising mutliple layers may be ultrasonically bonded after applying the coating of one or more of the layers. Alternatively layers may be bonded together by needlepunch, thermal bonding, chemical bonding, or sonic bonding prior to applying the coating and/or impregnation.

The means for affixing the impregnated water insoluble substrate to the interior surface of the garbage bag is preferably an adhesive means. An adhesive coating can be coated onto one surface of the impregnated water insoluble substrate and a peel layer of plastic can then be applied to the exposed surface of the adhesive coating. Alternatively, a tape having adhesive on both sides can be affixed to one surface of the impregnated water insoluble substrate and then the adhesive tape is secured to the interior surface of the garbage bag.

The following examples illustrate liquid cleaning compositions of the described invention. Unless otherwise specified, all percentages are by weight. The exemplified compositions are illustrative only and do not limit the scope of the invention. Unless otherwise specified, the proportions in the examples and elsewhere in the specification are by weight.

### EXAMPLE 1

The following composition (in wt. %) was prepared by simple batch mixing at room temperature. The fragrance pad was made by the previously described impregnation process.

| | A | B | C |
|---|---|---|---|
| Hydraspun 8579 | 90.68 | 90.81 | 90.91 |
| Dipropylene glycol | 7.98 | 7.99 | 8 |
| Glydant | 0.25 | 0 | 0 |
| Glycacyl | 0 | 0.1 | 0 |

While particular embodiments of the invention and the best mode contemplated by the inventors for carrying out the invention have been shown, it will be understood, of course, that the invention is not limited thereto since modifications may be made by those skilled in the art, particularly in light of the foregoing teachings. It is, therefore, contemplated by the appended claims to cover any such modifications as incorporate those features which constitute the essential features of these improvements within the true spirit and scope of the invention.

1. A fragrance pad which comprises approximately:
(a) 60 wt. % to 99 wt. % of a water insoluble substrate;
(b) 1 wt. % to 40 wt. % of a fragrance solution being coated onto and impregnated into said water insoluble substrate, wherein said fragrance solution comprises:
(i) 5.0 wt. % to 25.0 wt. % of at least one fragrance;
(ii) 0.01 wt. % to 2 wt. % of at least one preservative; and
(iii) 75 wt. % to 95 wt. % of a humectant; and
(c) means for affixing said impregnated water soluble substrate to an interior surface of a garbage bag.
